(19) United States
(12) Patent Application Publication
(10) Pub. No.: US 2007/0169352 A1
(43) Pub. Date: Jul. 26, 2007

(54) Foldable cutter with sharpening device

(76) Inventor: Hirai Akira, Kawaguchi-shi (JP)

Correspondence Address: DICKSTEIN SHAPIRO LLP, 1825 EYE STREET NW, Washington, DC, 20006-5403, US

(21) Appl. No.: 11/405,627

(22) Filed: Apr. 18, 2006

(30) Foreign Application Priority Data
Jan. 26, 2006 (JP) P2006-17840

(51) Int. Cl. B26B 3/06; F41B 13/02

(52) U.S. Cl. 30/155

(57) ABSTRACT

Disclosed is a foldable cutter with a sharpening device, capable of containing a blade thereof in a handle and capable of easily and semiautomatically sharpening the cutting edge of the blade when the blade is received in the handle. The foldable cutter with a sharpening device comprises a blade having a cutting edge at one side thereof; a handle for receiving the blade therein when the blade is not in use, in which the blade is pivotably coupled to the handle by a pivot shaft in a manner such that the blade can be received in the handle by rotating the blade into the handle; a whetstone plate installed in the handle via an elastic member with a tilted orientation at a position on a moving path of the blade in the handle, such that the blade is in contact with and sliding along a surface of the whetstone plate during a motion in which the blade is received in the handle, whereby the cutting edge of the blade is sharpened easily and semiautomatically during a motion in which the blade is received in the handle.

### BACKGROUND OF THE INVENTION

1. Field of the Invention

The present invention relates to a foldable cutter capable of containing a blade in a handle by rotating the blade into the handle. More particularly, the present invention relates to a foldable cutter having a sharpening device, capable of sharpening the cutting edge of a blade by sharpening the cutting edge of the blade against the surface of a whetstone plate disposed in a handle with a tilted orientation through a motion of rotating the blade into the handle, which is the motion for putting the blade into the handle, so that the foldable cutter has the advantages of being capable of always maintaining the sharpness of the cutting edge and contributing to the reduction of the amount of dangerous rubbish such as pieces of broken blades, which is a problem with conventional foldable cutters, thereby resulting in the reduction of consumption of natural resources.

2. Description of the Related Art

Generally, blades of conventional sliding-type foldable cutters are made of stainless steel or other steels. Most of them are have low hardness of about HV700 or less. Accordingly, even after being used for a short time of use, the cutting edge of the blade is easily worn away, and the blade is easily broken when the cutting edge of the blade is worn. Further, since the design of the cutter is devised in a manner such that when a blade thereof is received in a receptacle, the tip of the blade of the sliding cutter wears out more quickly and is easily broken. As a result, a lot of dangerous waste is generated.

A blade of a sliding-type foldable cutter becomes dull because the cutting edge of the blade is gradually worn out while it is used. When the cutting edge of a blade is worn out, the entire body of the blade, which corresponds to several tens of times the size of the cutting edge, is discarded after it is used. This wastes natural resources. On the other hand, nowadays blades of cutters become dull after being used for even a short time because tape, rope, laces, papers, and packaging materials, which are general objects to be cut by the cutters, contain rigid substances therein, so that the blade is quickly worn out and the amount of the broken blades to be discarded sharply increases. The dulled cutting edge of a blade can be sharpened merely by simply sharpening the blade's cutting edge using a whetstone. However, since the cutting edge of a blade of the conventional foldable cutter is very thin and small, it is difficult to sharpen the blades of the foldable cutters. For this reason, most of people discard the cutters with dulled blades instead of reusing the cutters by sharpening the blades of the cutters. Accordingly, a cutter having a sharpening device that can easily and automatically sharpen a cutting edge of a blade contributes to the conservation of cutting tools.

As described above, foldable cutters are frequently used in daily lives to cut plastic film, vinyl laces, corrugated cardboard, and packing papers. Worldwide, many blades of foldable cutters are discarded every day because the blades become dull or because they break. This is because the blades of the cutters are generally made of a material having a low hardness of about HV700 or less, so that people habitually throw away a cutter whose blade is dull, and use a new cutter. On the other hand, nowadays, the lifespan of a blade of a foldable cutter is decreasing, and the number of discharged blades of foldable cutters increases because the cutters are used to cut films and tapes which are made of highly rigid plastic materials containing a variety of hybrids, with the improvement of manufacturing technologies for synthetic materials such as plastics. The increase in the number of discarded foldable cutters results in the waste of natural resources and environmental disruption because the discarded blades are dangerous waste. In conclusion, it is unreasonable to discard the entire blade of a cutter whose blade is considered just because only a small portion of the cutting edge is dulled, in light of economics and environmental pollution.

In order to solve the problems above, some improved cutters have been disclosed.

A first prior art (Prior art 1) discloses a cutter having an abrasive material and a whetstone at a front portion of a sleeve provided in a cutter main body 1, so that the cutting edge of the cutter can be sharpened by the abrasive material and the whetstone every time the blade is withdrawn into the sleeve. Further, the cutter additionally comprises an accessory portion detachably installed at the rear end of the cutter main body 1 to be used to break away a dulled section of a segmented blade of the cutter, the accessory portion having a dent mounted with an abrasive material and a whetstone. Accordingly, the cutting edge of the cutter can be sharpened by rubbing the abrasive material and the whetstone provided in the accessory portion 5 on the dulled cutting edge of the cutter blade. As a result, the lifespan of the blade of the cutter can be prolonged, and the cutter is advantageous from an economical aspect. A second prior art (Prior art 2) discloses a cutter comprising a main body 1 having a depression 6 at a rear end portion thereof, in which whetstones 8a and 8b mounted on a whetstone support 7 are disposed in the depression in a detachable manner. A third prior art (Prior art 3) discloses a cutter X comprising a blade 1, a main body 2 for supporting the blade 1, and a whetstone 3 detachably attached to the main body 2. The whole or part of at least one of a pair of side surfaces 21a and 21b, which are located across a gap in the thickness direction of the blade body 1, of the external surfaces of the main body 2 is formed into a flat-surface-shape slope which tilts to the central line L in the thickness direction of the blade body 1. When sharpening the tip 13 of the blade 1 using the whetstone 3, the main body 2 is placed on a base 5 in a manner such that the slope comes into contact with the surface 51 of the desired base 5. Thus, the blade body 1 can be set under a tilted posture wherein the blade body 1 is displaced upward.

[Prior art 1] Japanese Utility Model Registration No. 3021710

[Prior art 2] Japanese Utility Model Registered Publication No. Hei3-39181

[Prior art 3] Japanese Patent Laid-Open Publication No. 2004-229744

However, the cutter disclosed in the first prior art has the following problems. The prior art 1 discloses the abrasive material and the whetstone assembled into the cutter, but the structure in which the abrasive material and the whetstone 6 are assembled at the front end of the sleeve of the cutter main body 1 cannot be implemented even through a close studying of the prior art 1. Further, even though the cutter in the prior art 1 has an accessory portion having a dent mounted with the abrasive material and the whetstone, that is, although the cutter has a sharpening device, it is impossible to sharpen the cutting edge of the blade through the motion for retracting the blade into the cutter main body 1. That is, the blade of the cutter can be sharpened by gripping the accessory portion and rubbing the abrasive and the whetstone provided in the accessory portion against the cutting edge of the blade before putting the blade in the cutter main body 1. Further, since the sharpening direction is parallel to the installing direction of the blade, the sharpening of the blade through the sharpening is ineffective. It is commonly known that a blade is effectively sharpened when the sharpening direction is perpendicular to the cutting edge of the blade. Accordingly, sharpening is generally performed in a direction perpendicular to the cutting edge of the blade, since sharpening in the direction parallel to the cutting edge of a blade is not effective. That is, the sharpness of a blade cannot be achieved merely by reducing the thickness of a blade.

The second prior art discloses a cutter comprising a main body 1 having a depression 6 in which the whetstone base 7, onto which a whetstone 8, 8a, 8b is attached, is detachably disposed. When sharpening the blade of the cutter, the whetstone base 7 is detached from the main body 1, and then, the sharpening is performed by gripping and rubbing the whet stone 8, 8a, 8b against the cutting edge of the blade. According to this prior art, although the whetstone is enclosed in the main body 1 of the cutter, the method of sharpening the blade is exactly the same as conventional sharpening methods conducted in the case in which the cutter and the sharpening device are separated.

Disclosed in the prior art 3 is the cutter X having a whetstone 3 detachably attached to the main body 2 that supports the blade 1. When sharpening the cutting edge 13 of the blade 1 using the whetstone 3, the main body 2 is placed on the base 5 in a manner such that angled portion of the blade 1 is brought into contact with the surface 51 of the base 5, so that the blade 1 can be set in a tilted posture in which the blade 1 is displaced upward. When the blade 1 needs to be sharpened, the whetstone 3 is separated from the main body 2 and is placed on the desired base. Accordingly, even in this prior art, the method of sharpening the blade body is exactly the same as the conventional sharpening methods conducted in the case in which the cutter and the sharpening device are separated.

### SUMMARY OF THE INVENTION

Accordingly, the present invention has been made keeping in mind the above problems occurring in the prior arts, and an object of the present invention is to provide a foldable cutter with a sharpening device, comprising: a blade having a cutting edge at one side thereof; a handle for receiving the blade therein when the blade is not in use, in which the blade is pivotably coupled to the handle by a pivot shaft in a manner such that the blade can be received in the handle by rotating the blade into the handle; a whetstone plate installed in the handle via an elastic member with a tilted orientation at a position on a moving path of the blade in the handle, such that the blade is in contact with and sliding along a surface of the whetstone plate during a motion in which the blade is received in the handle, whereby the cutting edge of the blade is sharpened easily and semiautomatically during a motion in which the blade is received in the handle.

The foldable cutter may further comprise a whetstone plate tilt adjusting unit for adjusting a contact angle between the surface of the whetstone plate and the cutting edge of the blade, or holding the whetstone plate in a position where the whetstone plate does not contact with the cutting edge of the blade.

The blade may be made of corrosive metal, anticorrosive metal, ceramic, diamond grain composite, nitride composite, carbide grain composite, oxide grain composite, rigid substance grain thermoplastic resin composite, or rigid substance grain thermosetting resin composite.

The whetstone plate may be made of natural whetstone, synthetic whetstone, ceramic, diamond, or plastic composite.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a front view illustrating a foldable cutter with a sharpening device, in a state of being used, according to an embodiment of the present invention;

FIG. 2 is a sectional view illustrating the foldable cutter with a sharpening device, according to the embodiment of the present invention, in which a blade thereof is disposed in a handle;

FIG. 3 is a sectional view illustrating the foldable cutter with a sharpening device, according to the embodiment of the present invention, in which a blade thereof is about to be received in a handle;

FIG. 4 is a sectional view illustrating the foldable cutter with a sharpening device according to the embodiment of the present invention, in which a cutting edge of a blade is in contact with the sharpening device; and

FIG. 5 is a sectional view illustrating the foldable cutter with a sharpening device according to the embodiment of the present invention, in which a cutting edge of a blade is received in a handle.

### DETAILED DESCRIPTION OF THE INVENTION

Advantages and features of the present invention and methods of accomplishing the same may be understood more readily with reference to the following detailed description of preferred embodiments and the accompanying drawings.

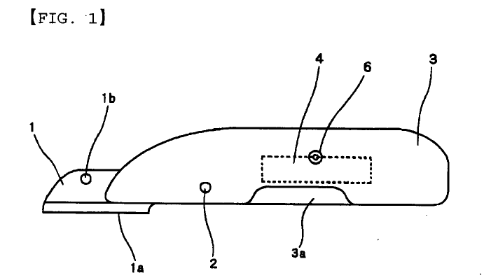

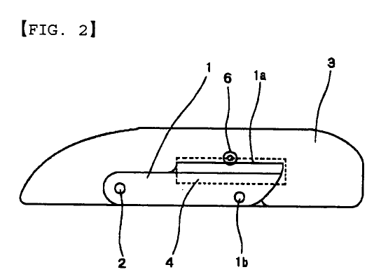

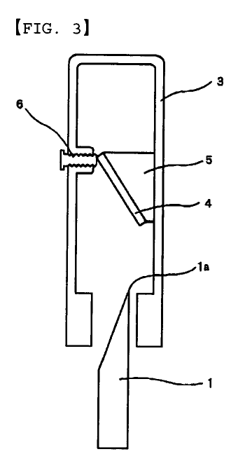

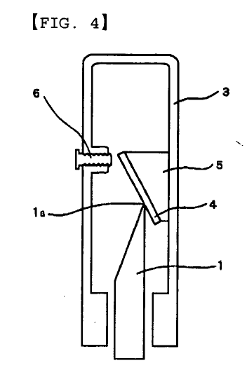

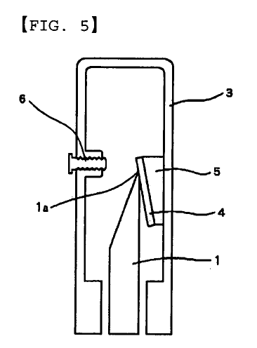

FIG. 1 is a front view illustrating a foldable cutter with a sharpening device, in a state of being used, according to an embodiment of the present invention, FIG. 2 is a sectional view illustrating the foldable cutter with a sharpening device, according to the embodiment of the present invention, in which a blade thereof is disposed in a handle, FIG. 3 is a sectional view illustrating the foldable cutter with a sharpening device, according to the embodiment of the present invention, in which a blade thereof is about to be received in a handle, FIG. 4 is a sectional view illustrating the foldable cutter with a sharpening device according to the embodiment of the present invention, in which a cutting edge of a blade is in contact with the sharpening device, and FIG. 5 is a sectional view illustrating the foldable cutter with a sharpening device according to the embodiment of the present invention, in which the cutting edge of the blade is received in a handle.

The present invention discloses a foldable cutter with a sharpening device, capable of containing a blade 1 in a handle 3 through a motion of pivotally rotating the blade 1 into the handle 3.

According to claim 1 of the present invention, what is claimed is a foldable cutter with a sharpening device comprising a blade 1 having a cutting edge 1a at one side thereof; a handle 3 for receiving the blade 1 therein when the blade 1 is not in use, in which the blade 1 is pivotably coupled to the handle 3 by a pivot shaft 2 in a manner such that the blade 1 can be received in the handle 3 by rotating the blade into the handle 3; a whetstone plate 4 installed in the handle 3 via an elastic member 5 with a tilted orientation at a position on a moving path of the blade in the handle, such that the blade 1 is in contact with and sliding along a surface of the whetstone plate 4 during a motion in which the blade 1 is received in the handle 3, whereby the cutting edge 1a of the blade is sharpened easily and semiautomatically during a motion in which the blade 1 is received in the handle 3.

According to claim 2 of the prevent invention, what is claimed is the foldable cutter with a sharpening device claimed in claim 1, further comprising a whetstone plate tilt adjusting unit 6 for adjusting a contact angle between the surface of the whetstone plate 4 and the cutting edge 1a of the blade 1, or holding the whetstone plate 4 in a position such that the whetstone plate 4 does not contact with the cutting edge 1a of the blade 1.

According to claim 3 of the present invention, what is claimed is the foldable cutter with a sharpening device claimed in claim 1 or claim 2, wherein the blade 1 is made of corrosive metal, anticorrosive metal, ceramic, diamond grain composite, nitride composite, carbide grain composite, oxide grain composite, rigid substance grain thermoplastic resin composite, or rigid substance grain thermosetting resin composite.

According to claim 4 of the present invention, what is claimed is the foldable cutter with a sharpening device claimed in claim 1 or claim 2, wherein the whetstone plate 4 is made of natural whetstone, synthetic whetstone, ceramic, diamond, or plastic composite.

### Embodiment

The foldable cutter with a sharpening device has a blade 1 which has a flat, long and thin panel shape. The blade 1 has a cutting edge 1a at one side edge thereof, extending in the length direction of the blade. The cutting edge 1a is made by providing a slope to one face of the blade, or providing slopes to both faces of the blade so that the blade 1 has a sharp cutting edge 1a. The blade 1 pivots with respect to a handle 3 around a pivot shaft 2 fixed to an end portion of the handle 3. The blade 1 further has a protrusion 1b on the other side thereof opposite the cutting edge, so that the blade can be easily moved reversely from a first position of being received in the handle to a second position of being exposed from the handle and being ready for use, or moved in reverse from the second position to the first position by pushing the protrusion 1b.

The handle 3 serves to receive the blade 1 when the blade is pivotally moved around the pivot shaft 2. A cross-section of the handle 3 has a thin bowl shape. Referring to FIG. 1, when the blade 1 is ready for use, the arrangement of the blade 1 and the handle 3 form a straight bar, thereby being capable of performing the cutting operation while the handle 3 is held with a hand. Referring to FIG. 2, when the cutting operation is finished, the blade 1 is received in the handle 3 through a motion of rotating the blade 1 into the handle 3. The handle 3 has a depression 3a, so that the blade 1 can be easily exposed out of the handle 3. The handle 3 contains a whetstone plate 4 and an elastic member 5 in a receptacle formed therein and is equipped with a whetstone plate tilt adjusting unit 6.

The whetstone plate 4 has a thin plate shape and is preferably prepared by processing whetstone into a plate form. The whetstone 4 is installed in a tilted manner in the handle by the elastic member 5. The whetstone 4 is disposed at a position on a moving path of the blade 1 in the handle 3, so that the cutting edge 1a of the blade moves sliding along the sloped surface of the whetstone plate 4 during a motion in which the blade 1 is received in the handle 3.

The elastic member 5 is made of a leaf spring or sponge. The elastic member 5 serves to support the whetstone plate 4 in a tilted manner at a predetermined angle. The elastic member 5 further serves to push the whetstone plate 4 toward the blade 1 by its elastic force, so that the cutting edge 1a of the blade 1 can be brought into pressured contact with the sloped surface of the whetstone plate 4 at a slant when the blade 1 is pivoted toward the handle 3, and the cutting edge 1a of the blade 1 slides along the surface of the whetstone plate 4, resisting the elastic force of the elastic member 5. As a result, the cutting edge 1a of the blade 1 is sharpened.

The whetstone plate tilt adjusting unit 6 serves to freely adjust a contact angle between the cutting edge 1a of the blade 1 and the sloped surface of the whetstone plate 4. The whetstone plate tilt adjusting unit 6 comprises a threaded hole formed through the wall of the handle 3, a bolt received in the threaded hole in a manner such that the tip of the bolt is in contact with a end portion of the sloped sharpening surface of the whetstone plate 4. The tilt angle of the whetstone plate 4 is adjusted by screwing the bolt forward or backward. The tilt angle adjusting unit 6 effectively controls the sharpening angle of the cutting edge 1a of the blade 1 by screwing forward the bolt to push the end portion of the sharpening surface of the whetstone plate 4, against the elastic force of the elastic member 5. When sharpening is not needed, the bolt is further screwed forward to the whetstone plate 4, so that the cutting edge 1a of the blade 1 cannot come into contact with the sharpening surface of the whetstone plate 4.

When the blade 1 is folded inwards to a received position in which the blade 1 is received in the handle 3 as shown in FIG. 2 by a pivoting motion from a ready-for-use position shown in FIG. 1, the blade 1 moves according to the following sequence. That is, at first, the blade 1 is in the position shown in FIG. 3 right before the blade 1 is received in the handle 3, then the blade 1 is in a position of being in contact with the sloped surface of the whetstone plate 4 as shown in FIG. 4 as the blade 1 is more pivoted further, and then finally the blade 1 is in a posture of being disposed in the handle 3, as shown in FIG. 5, when the blade 1 is fully pivoted. At this time, since the elastic force of the elastic member 5 is applied to the whetstone plate 4 while the cutting edge 1a of the blade 1 slides along the sloped surface of the whetstone plate 4, the cutting edge 1a of the blade 1 is pressed against the whetstone plate 4 with adequate pressure. Accordingly, the cutting edge 1a of the blade 1 can be effectively sharpened.

Further, the blade 1 is made of corrosive metal, anticorrosive metal, ceramic, diamond grain composite, nitride composite, carbide grain composite, oxide grain composite, rigid substance thermoplastic resin composite, or rigid substance thermosetting resin composite.

The whetstone plate 5 is made of natural whetstone, synthetic whetstone, ceramic, diamond or plastic composite.

As described above, the foldable cutter according to the present invention is substantially different from prior art foldable cutters in which the cutting edge of a blade is easily broken if the blade is sharpened against a whetstone. That is, the foldable cutter according to the present invention can contain a blade in a handle when it is not in use, and has a whetstone plate in the handle thereof so as to sharpen the cutting edge of the blade when the blade is received in the handle. In this foldable cutter, the whetstone plate is installed in a manner such that the cutting edge of the blade moves in to the handle 3 while sliding along the surface of the whetstone plate at a predetermined angle of contact, so that the cutting edge of the blade is sharpened every time when the blade is rotated inwards so as to be received in the handle. As a result, the cutting edge of the blade can always be sharp, thereby the blade is not easily broken and thrown away, and the blade of the foldable cutter can be used for a long time. Accordingly, the foldable cutter according to the present invention is beneficial in that it reduces the generation of dangerous solid waste, and in that it allows natural resources to be effectively used by reducing consumption of the natural resources.

The foldable cutter according to the present invention is provided to prevent the waste of blades of cutters, which was the problem of conventional foldable cutters and resulted from the blades easily becoming dull and easily being broken. Further, the foldable cutter according to the present invention has the advantage of sharpening a blade of a cutter on the spot, thereby reducing the waste of natural resources. The foldable cutter according to the present invention has the further advantage of maintaining the sharpness of a blade, thereby having a long lifespan.

While the present invention has been shown and described with particular reference to exemplary embodiments thereof, it will be understood by those of ordinary skill in the art that various changes in form and details may be made thereto without departing from the spirit and scope of the present invention as defined by the following claims. Therefore, it is to be understood that the above-described embodiments has been provided only in a descriptive sense and is not to be construed as placing any limitation on the scope of the invention.

What is claimed is:

1. A foldable cutter with a sharpening device, comprising:
a blade having a cutting edge at one side thereof;
a handle for receiving the blade therein when the blade is not in use, in which the blade is pivotably coupled to the handle by a pivot shaft in a manner such that the blade can be received in the handle by rotating the blade into the handle;
a whetstone plate installed in the handle via an elastic member with a tilted orientation at a position on a moving path of the blade in the handle, such that the blade is in contact with and sliding along a surface of the whetstone plate during a motion in which the blade is received in the handle, whereby the cutting edge of the blade is sharpened easily and semiautomatically during a motion in which the blade is received in the handle.

2. The foldable cutter with a sharpening device as claimed in claim 1, further comprising a whetstone plate tilt adjusting unit for adjusting a contact angle between the surface of the whetstone plate and the cutting edge of the blade, or holding the whetstone plate in a position where the whetstone plate does not contact with the cutting edge of the blade.

3. The foldable cutter with a sharpening device as claimed in claim 1, wherein the blade is made of corrosive metal, anticorrosive metal, ceramic, diamond grain composite, nitride composite, carbide grain composite, oxide grain composite, rigid substance grain thermoplastic resin composite, or rigid substance grain thermosetting resin composite.

4. The foldable cutter with a sharpening device as claimed in claim 1, wherein the whetstone plate is made of natural whetstone, synthetic whetstone, ceramic, diamond, or plastic composite.

5. The foldable cutter with a sharpening device as claimed in claim 2, wherein the blade is made of corrosive metal, anticorrosive metal, ceramic, diamond grain composite, nitride composite, carbide grain composite, oxide grain composite, rigid substance grain thermoplastic resin composite, or rigid substance grain thermosetting resin composite.

6. The foldable cutter with a sharpening device as claimed in claim 2, wherein the whetstone plate is made of natural whetstone, synthetic whetstone, ceramic, diamond, or plastic composite.
